(19) United States
(12) Patent Application Publication
(10) Pub. No.: US 2025/0020911 A1
(43) Pub. Date: Jan. 16, 2025

(54) ILLUMINATION MODULES INCLUDING OPTICAL ELEMENTS TO PRODUCE LIGHT STEERING FUNCTIONS OR DIFFERENT ILLUMINATION PATTERNS

(71) Applicant: NIL Technology ApS, Kongens Lyngby (DK)

(72) Inventors: Olivier Francois, Kongens Lyngby (DK); Daryl Lafleur, Ottawa (CA)

(21) Appl. No.: 18/712,041

(22) PCT Filed: Nov. 16, 2022
(86) PCT No.: PCT/EP2022/082105

§ 371 Date: May 21, 2024

Related U.S. Application Data
(60) Provisional application No. 63/281,930, filed on Nov. 22, 2021.

(51) Int. Cl. G02B 26/08; G02B 1/00; G02B 26/10

(52) U.S. Cl. CPC G02B 26/0808; G02B 1/002; G02B 26/10

(57) ABSTRACT

The present disclosure describes illumination modules that include at least one diffractive optical element (DOE) or meta-optical element (MOE) having a phase function operable to provide light steering functions and/or to produce any of a range of different light patterns in the far-field. In some implementations, for example, the phase delay imparted by the MOE or DOE is a function of the incident angle of the light impinging on the optical element. In some implementations, the MOE or DOE has a phase function such that the light pattern produced by the optical element depends on the incident angle of the light impinging on the optical element. The illumination modules can be incorporated into illumination and imaging systems.

### FIELD OF THE DISCLOSURE

The present disclosure relates to illumination modules.

### BACKGROUND

Illumination modules, together with sensors, can facilitate the collection of information, such as proximity, distance to or between objects, and other three-dimensional data by various techniques (e.g., structured light or time-of-flight). Typically, a scene in the far field is illuminated by an illumination module, and light reflected from one or more objects in the scene is collected by a sensor. Sometimes the entire scene is illuminated, for example, over a wide field of illumination by the illumination module at the same time. In such situations, however, thermal management, eye-safety, and/or power consumption concerns may arise.

### SUMMARY

The present disclosure describes illumination modules that include at least one diffractive optical element (DOE) or meta-optical element (MOE) having a phase function operable to provide light steering functions and/or to produce any of a range of different light patterns in the far-field. In some implementations, for example, the phase delay imparted by the MOE or DOE is a function of the incident angle of the light impinging on the optical element. In some implementations, the MOE or DOE has a phase function such that the light pattern produced by the optical element depends on the incident angle of the light impinging on the optical element.

For example, in one aspect, the present disclosure describes an apparatus that includes an optical element, wherein the optical element is a DOE or MOE. The apparatus also includes a beam steering system operable to produce intermediate light incident on the optical element at any of different incident angles. The optical element is configured to generate a far-field illumination based on the intermediate light, wherein a direction of the far-field illumination depends on an angle at which the intermediate light is incident on the optical element.

Some implementations include one or more of the following features. For example, in some cases, the optical element has a phase function such that a phase delay imparted by the optical element depends on the incident angle of the intermediate light. In some instances, for at least some incident angles of the intermediate light impinging on the optical element, the optical element is operable to produce the far-field illumination at a respective output angle greater than the incident angle of the intermediate light.

In some implementations, the beam steering system includes an optical phase array and/or a light emitter operable to produce coherent light as the intermediate light. In some implementations, the apparatus further includes a controller operable to control the beam steering system to produce a sequence of two or more light beams, wherein each of the light beams has a different respective angle of incidence on the optical element, and wherein a respective direction of the far-field illumination produced by the optical element differs for each of the light beams.

The present disclosure also describes an apparatus that includes an array of optical elements, each of which is a DOE or MOE. The apparatus also includes a plurality of light emitters, each of which is operable to produce respective intermediate light incident on a respective one of the optical elements. Each particular one of the optical elements has a respective phase function configured to generate a respective far-field illumination based on the respective intermediate light incident on the particular one of the optical elements. The far-field illumination produced by the particular one of the optical elements is in a direction different from the far-field illuminations produced by other ones of the optical elements.

Some implementations include one or more of the following features. For example, in some cases, each of the light emitters is operable, respectively, to produce coherent light as the intermediate light. In some instances, the apparatus further includes at least one collimator configured so that the intermediate light incident on the optical elements is substantially collimated. The array of optical elements can be, for example, a one-dimensional or a two-dimensional array. In some implementations, the apparatus includes a controller operable to turn on different groupings of the light emitters at different times.

The present disclosure also describes an apparatus that includes an optical element, wherein the optical element is a DOE or MOE. The apparatus also includes a beam steering system operable to produce intermediate light incident on the optical element at any of different incident angles. The optical element is configured to generate a far-field illumination based on the intermediate light, wherein a pattern of the far-field illumination depends on an angle at which the intermediate light is incident on the optical element.

Some implementations include one or more of the following features. For example, in some cases, the optical element is operable to generate a first pattern in the far-field illumination when the intermediate light is incident on the optical element at a first angle and to generate a second different pattern in the far-field illumination when the intermediate light is incident on the optical element at a second angle, wherein the second angle differs from the first angle, and the second pattern differs from the first pattern. In some instances, the optical element is further operable to generate a third pattern in the far-field illumination when the intermediate light is incident on the optical element at a third angle, wherein the third angle differs from the first and second angles, and the third pattern differs from the first and second patterns.

In some implementations, the optical element is configured to be operable to produce at least two different respective patterns for the far-field illumination depending on an angle at which the intermediate light is incident on the optical element, wherein the patterns are from a group consisting of: a dot pattern, a line pattern, structured light, diffuse light, and light having a particular polarization. In some cases, the apparatus includes a controller operable to control the beam steering system to produce a sequence of two or more light beams, wherein each of the light beams has a different respective angle of incidence on the optical element, and wherein a respective pattern for the far-field illumination produced by the optical element differs for each of the light beams.

Some implementations may help improve thermal management, eye-safety, and/or power consumption of the illumination modules. Further, some implementations can provide greater flexibility in obtaining characteristic information of objects in a scene (e.g., proximity data, distance to or between objects, or other three-dimensional data). In some implementations, the output illumination can be deflected over a larger angle than would otherwise be achievable by the beam steering system alone. In some implementation, the illumination modules can facilitate concentrating light in a specific direction, so as to achieve, for example, higher instant signal-to-noise ratio (SNR).

Other aspect, features and advantages will be readily apparent from the following detailed description, the accompanying drawings, and the claims.

### BRIEF DESCRIPTION OF THE DRAWINGS

FIGS. 1A and 1B illustrate a first example of an illumination module.

FIG. 2 is a flow chart of a method of determining characteristic information of a scene using an illumination module.

FIGS. 3A and 3B illustrate a second example of an illumination module.

FIGS. 4A, 4B and 4C illustrate a third example of an illumination module.

FIGS. 5A, 5B and 5C illustrate a fourth example of an illumination module.

FIG. 6 illustrates an example of an illumination and imaging system.

### DETAILED DESCRIPTION

MOEs and DOEs employ a flat optic technology. MOEs, for example, have a metasurface that includes distributed small subwavelength structures (e.g., nanostructures or other meta-atoms) arranged to interact with light in a particular manner. The meta-atoms can, individually and/or collectively, interact with light waves to change a local amplitude, a local phase, or both, of an incoming light wave. Likewise, DOEs have microstructure patterns that alter and control the phase of an incoming light wave. By altering the microstructures, it is possible for a DOE to produce a range of beam intensity profiles or beam shapes. MOEs or DOEs can be used, for example, in optical applications to take advantage of the flat surface and reduced thickness, compared to classic, curved refractive lenses.

The present disclosure describes illumination modules that include at least one DOE or MOE having a phase function operable to provide light steering functions and/or to produce any of a range of different light patterns in the far-field. In some implementations, for example, the phase delay imparted by the MOE or DOE is a function of the incident angle of the light impinging on the optical element. In some implementations, the MOE or DOE has a phase function such that the light pattern produced by the optical element depends on the incident angle of the light impinging on the optical element.

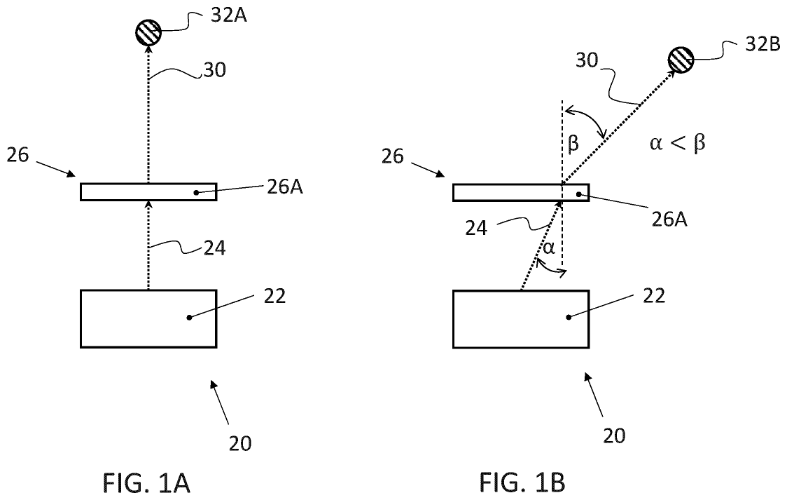

FIGS. 1A and 1B illustrate an example of a first illumination module 20 that includes a beam steering system 22 operable to produce an intermediate beam of light 24 at a particular wavelength or within a particular wavelength range (e.g., infra-red (IR), near IR, or visible). The beam steering system 22 may include for example, one or more light sources, rotatable mirrors or other reflective surfaces, and control circuitry. For example, in some cases, the beam steering system 22 includes a light source and an integrated microelectromechanical system (MEMS) device. The output beam can be coherent, such as light emitted from a laser. In some instances, the light source includes a vertical cavity surface emitting laser (VCSEL) array or an array of edge emitting lasers. In some implementations, the beam steering system 22 includes an optical phase array (OPA). In some implementations, the beam steering system 22 includes waveguides and out-coupling structures configured to emit light in predetermined positions and directions. The beam steering system 22 is operable to direct the intermediate beam of light 24 toward a lens system 26 at any one of multiple different incident angles.

The lens system 26 includes at least one MOE or DOE 26A that has a phase function such that the phase delay imparted by the MOE or DOE depends on the incident angle of the light. The phase function of the optical element 26A is configured to generate an illumination 30 in the far-field such that the direction of the far-field illumination depends on the angle at which the intermediate beam of light 24 is incident on the optical element 26A. As shown in the example of FIG. 1A, if the intermediate light beam 24 impinges on the optical element 26A at a first incident angle (e.g., normal to the surface of the optical element), the optical element 26A produces an output illumination 30 (i.e., beam of light) at a first output angle (e.g., normal to the surface of the optical element). On the other hand, as shown in FIG. 1B, if the intermediate light beam 24 impinges on the optical element 26A at a second incident angle α, the optical element 26A produces an output illumination 30 at a second output angle β, where the output angle β is greater than the incident angle α. As the output angle β is larger than the incident angle α, the output illumination 30 can be deflected over a larger angle than would otherwise be achievable by the beam steering system 22 alone. The phase function of the optical element 26A allows the module 20 to control the output angle of the illumination based, in part, on the different angles of incidence of the light 24 on the optical element 26A so as to achieve different output or deflection angles.

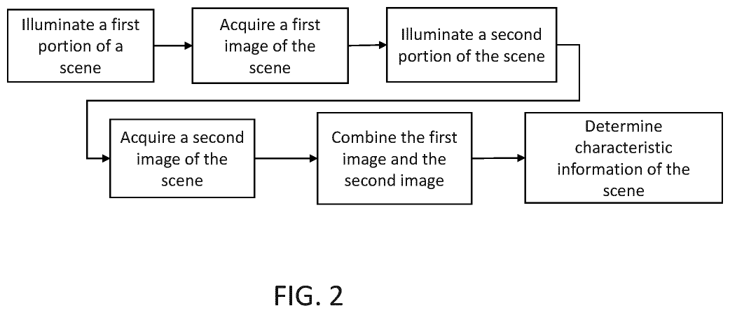

In some implementations, the illumination module 20 is configured to illuminate different regions (e.g., 32A, 32B) of a scene in the far-field sequentially. That is, as indicated by FIG. 2, a first region of the scene can be illuminated at a first time t1, and a first image of the scene can be acquired (e.g., by a CMOS camera or other imaging device) based on the first illumination light reflected from the scene. Then a second region of the scene can be illuminated at a subsequent second time t2, and a second image of the scene can be acquired based on the second illumination light reflected from the scene. One or more processors can determine characteristic information of the scene based on the acquired images. In some cases, the illumination module 20 may consume less power and may generate a smaller luminance than an illumination module configured to illuminate the entire scene simultaneously, while still achieving the same scene luminance per unit area. In some instances, there may be partial overlap among the different regions of the scene that are illuminated sequentially. Also, in some instances, more than two regions of the scene may be illuminated sequentially. Images can be acquired (e.g., by an imaging device) based on light reflected from the scene for each respective illumination, and the images can be processed to obtain characteristic information about the scene. The characteristic information may include, for example, proximity data, distance to or between objects, or other three-dimensional data. In some implementation, the module 20 can facilitate concentrating light in a specific direction, so as to achieve, for example, higher instant signal-to-noise ratio (SNR).

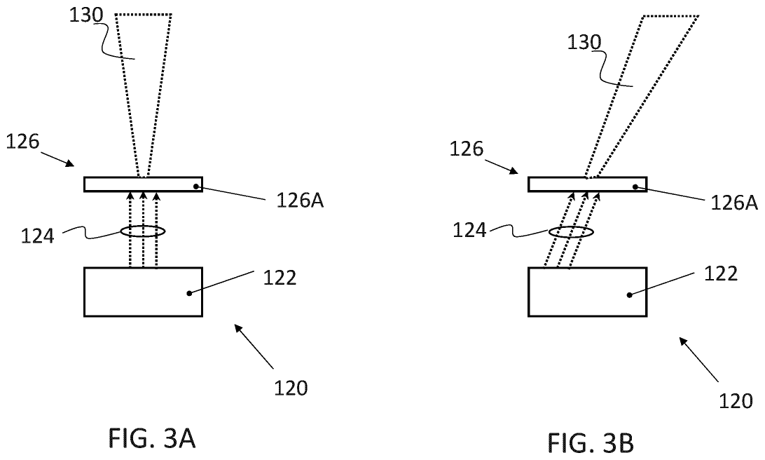

In the example of FIGS. 1A and 1B, light 24 is launched from substantially the same location out of the beam steering system 22, but impinges on different areas of the optical element 26A depending on the angle of incidence. The phase function varies across different regions of the optical element 26A so that a desired respective deflection angle is achieved for each angle of incidence. On the other hand, in some implementations, as shown in the example illumination module 120 of FIGS. 3A and 3B, light 124 is launched from different locations out of a beam steering system 122, but impinges on substantially the same area of an optical element 126A.

The beam steering system 122 may include for example, one or more light sources, rotatable mirrors or other reflective surfaces, and control circuitry. The output beam(s) can be coherent, such as light emitted from a laser. In some instances, the light source includes VCSEL array or an array of edge emitting lasers. In some implementations, the beam steering system 122 includes an OPA. The beam steering system 122 is operable to direct the intermediate beam(s) of light 124 toward a lens system 126 at any of multiple different incident angles.

The lens system 126 includes at least one MOE or DOE 126A that has a phase function in which the phase delay imparted by the MOE or DOE depends on the incident angle of the light. Here as well, the phase function of the optical element 126A is configured to generate an illumination 130 in the far-field 128 such that the direction of the far-field illumination depends on the angle and polarization at which the intermediate beam of light 124 is incident on the optical element 126A. Thus, as shown in FIG. 3A, the intermediate beam(s) 124 can be steered such that they are incident on the optical element 126A at a first angle of incidence, whereas as shown in FIG. 3B, at other times, the intermediate beam(s) are steered such that they are incident on the optical element 126A at a different angle of incidence. Regardless of the angle of incidence, the intermediate beams 124 illuminate substantially the same area of the optical element 126A. The optical element 126A, however, is configured to generate illuminations 130 on different areas of a scene depending on the angle of incidence of the intermediate beam(s). That is, the deflection angle introduced by the phase function of the optical element 126A depends on the angle of incidence of the intermediate light 124. Thus, the phase function of the optical element 126A allows the module 120 to control the output angle of the illumination based, at least in part, on the different respective angles of incidence of the light 124 on the optical element 126A so as to achieve different output or deflection angles.

In some implementations, the illumination module 120 is configured to illuminate different portions of a scene in the far-field sequentially as described, for example, in connection with FIG. 2. That is, images can be acquired (e.g., by an imaging device) based on light reflected from the scene for each respective illumination, and the images can be processed to obtain characteristic information about the scene. The characteristic information may include, for example, proximity data, distance to or between objects, or other three-dimensional data. In some implementation, the module 120 can facilitate concentrating light in a specific direction, so as to achieve, for example, higher SNR.

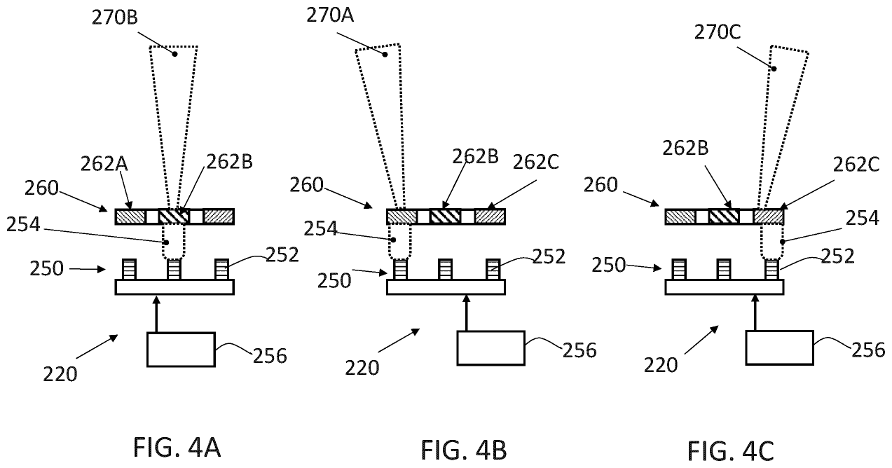

FIGS. 4A, 4B and 4C illustrate another example of an illumination module 220 that includes an array 250 of coherent light emitters 252, such as an array of VCSELS. In some cases, each light emitter 252 includes an integrated collimator such that the output beam 254 emitted by each light emitter is substantially collimated. Preferably, each light emitter 252 is operable to be controlled (i.e., turned on or off) by control circuitry 256 independently of other ones of the light emitters. In some instances, different groupings (e.g., subsets) of the light emitters 252 can be turned on or off together. The module 220 also includes an array 260 of optical elements 262A, 262B, 262C (collectively, optical elements 262) arranged such that light 254 emitted by each particular emitter 252 is directed to a respective one of the optical elements. For example, each respective optical element 262A, 262B, 262C can be aligned with a respective one of the light emitters 252 such that the collimated beam from each one of the light emitters 252 is incident on a respective one of the optical elements 262.

Each of the optical elements 262 can be, for example, a MOE or DOE. Further, each of the optical elements 262 (i.e., each MOE or DOE in the array 260) has a respective phase function configured to generate a respective illumination on a different respective area of a scene in the far-field. For example, in FIGS. 4A-4C, a first optical element 262A has a phase function that generates an illumination 270A on a first area of the scene, a second optical element 262B has a phase function that generates an illumination 270B on a second area of the scene, and a third optical element 262C has a phase function that generates an illumination 270C on a third area of the scene. Although FIGS. 4A-4C show an array 250 that includes only three emitters and an array 260 that includes only three optical elements, in some implementations there may be more emitters and optical elements. Further, the arrays may be one-dimensional or two-dimensional, depending on the implementation. In some implementations, the collimation function and steering function can be combined in the optical elements 262.

The illumination module 220 also can be operated sequentially (e.g., by turning on different ones, or different groupings, of the emitters at different times) such that different portions of a scene are illuminated at different times. As described above, images can be acquired (e.g., by an imaging device) based on light reflected from the scene for each respective illumination, and the images can be processed to obtain characteristic information about the scene. The characteristic information may include, for example, proximity data, distance to or between objects, or other three-dimensional data. In some implementation, the module 220 can facilitate concentrating light in a specific direction, so as to achieve, for example, higher instant signal-to-noise ratio (SNR).

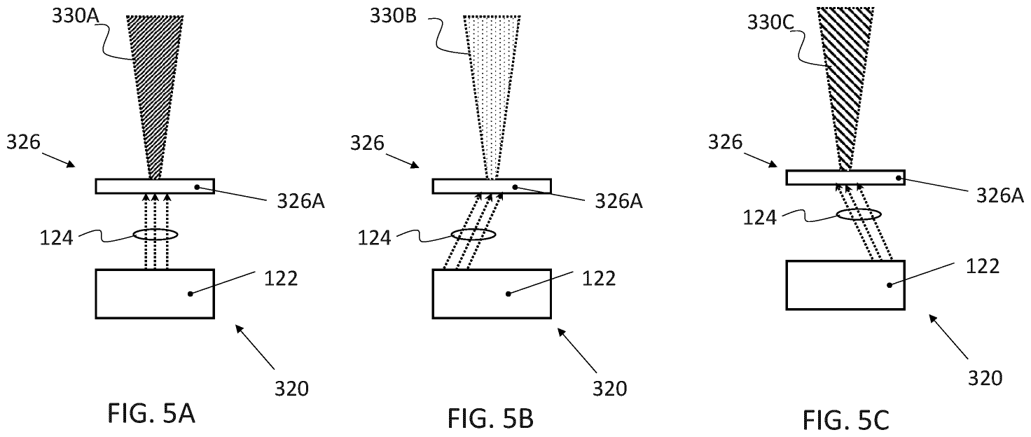

FIGS. 5A, 5B and 5C illustrate another example of an illumination module 320 in which light 124 is launched from a beam steering system 122, and impinges on an optical element 326A of a lens system 326. The beam steering system 122, which is operable to direct the intermediate beam(s) of light 124 toward the lens system 326 at any of multiple different incident angles, can be implemented as described above in connection with FIGS. 3A, 3B and 3C.

The optical element 326A can be implemented as a MOE or DOE that has a phase function configured to generate an illumination in the far-field where the far-field illumination depends on the angle at which the intermediate beam(s) of light 124 are incident on the optical element 326A. In particular, the optical element 326A has a phase function such that the light pattern produced at the output of the optical element depends on the incident angle of the light impinging on the optical element.

As shown in FIG. 5A, intermediate light 124 can be steered by the beam steering system 122 such that it is incident on the optical element 326A at a first angle of incidence, whereas as shown in FIG. 5B, at other times, the intermediate light is steered such that it is incident on the optical element 326A at a different angle of incidence, and in FIG. 5C, the intermediate light is steered, at yet other times, such that it is incident on the optical element 326A at yet another angle of incidence. Although the intermediate light 124 in each case illuminates substantially the same area of the optical element 326A, the optical element 326A is configured to generate respective far-field illuminations each of which has a light pattern that depends on the angle of incidence of the intermediate light. For example, when the intermediate light 124 impinges on the optical element 326A at a first angle as shown in FIG. 5A, the far-field illumination 330A may have a first light pattern. When the intermediate light 124 impinges on the optical element 326A at a second angle as shown in FIG. 5B, the far-field illumination 330B may have a second light pattern that differs from the first light pattern. When the intermediate light 124 impinges on the optical element 326A at a third angle as shown in FIG. 5C, the far-field illumination 330C may have a third light pattern that differs from both the first and second light patterns. In each case, the light pattern generated by the optical element 326A may include, for example, a dot pattern, a line pattern, structured light (e.g., grids or horizontal bars), diffuse light, or light having a particular polarization, or some combination of the foregoing patterns.

In some implementations, the beam steering system 122 includes an OPA, in which case there can be polarization control on the intermediate beam 124. The polarization control can facilitate, for example, better control in the change of far-field illumination as a function of incident angle and polarization.

The different illuminations 330A, 330B, 330C may be optimized for any number of different aspects of a scene that may be encountered when illuminating the scene to collect data and determine characteristic information of the scene. For example, in a particular implementation, the first illumination 330A may be used to illuminate an object at a first distance, whereas the second or third illuminations 330B, 330C may be used to illuminate an object at a second distance. In another example, the first illumination 330A may be used to illuminate a first object with a spectral characteristic, whereas the second or third illuminations 330B, 330C may be used to illuminate another object having a spectral characteristic different from the first object. The various illuminations 330A, 330B, 330C can be produced, for example, sequentially (i.e., at different times).

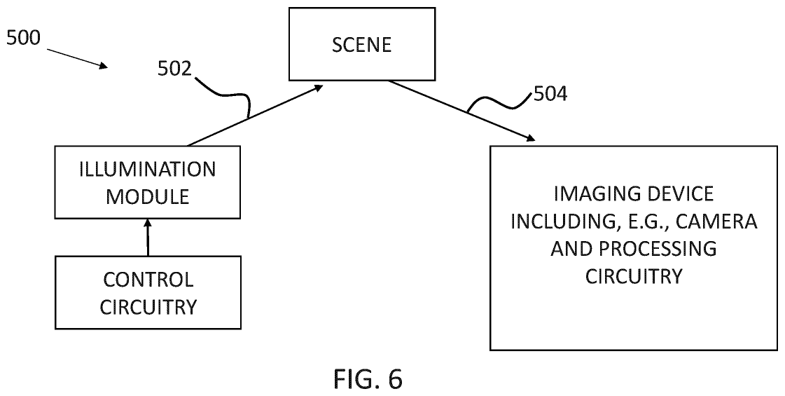

FIG. 6 illustrates an example of an illumination and imaging system 500 that includes an illumination module operable to illuminate a scene with light 502. The illumination module of FIG. 6 can be implemented, for example, as any one of the modules 20 (FIGS. 1A-1B), 120 (FIGS. 3A-3B), 220 (FIGS. 4A-4C) or 320 (FIGS. 5A-5C), One or more objects in the scene reflect some of the light, and reflected light 504 is sensed by an imaging device that includes, for example, a CMOS camera or other light sensor, as well as processing circuitry to process the sensed light signals and derive characteristic information about the scene. Control circuitry can be provided to control, for example, turning the light emitters in the illumination module on and off, and to control beam steering functions of the illumination module, as appropriate.

The processes and logic flows described in this specification can be performed by one or more programmable processors executing one or more computer programs to perform functions by operating on input data and generating output. The processes and logic flows can also be performed by, and apparatus also can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment also can be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous.

Various modifications will be readily apparent and can be made to the foregoing examples. Accordingly, other implementations also are within the scope of the claims.

1. An apparatus comprising:
an optical element, wherein the optical element is a diffractive optical element (DOE) or a meta-optical element (MOE); and
a beam steering system operable to produce intermediate light incident on the optical element at any of different incident angles,
wherein the optical element is configured to generate a far-field illumination based on the intermediate light, and wherein a direction of the far-field illumination depends on an angle at which the intermediate light is incident on the optical element.

2. The apparatus of claim 1, wherein the optical element has a phase function such that a phase delay imparted by the optical element depends on the incident angle of the intermediate light.

3. The apparatus of claim 1, wherein for at least some incident angles of the intermediate light impinging on the optical element, the optical element is operable to produce the far-field illumination at a respective output angle greater than the incident angle of the intermediate light.

4. The apparatus of claim 1, wherein the beam steering system includes an optical phase array.

5. The apparatus of claim 1, wherein the beam steering system includes a light emitter operable to produce coherent light as the intermediate light.

6. The apparatus of claim 1, further including a controller operable to control the beam steering system to produce a sequence of two or more light beams, wherein each of the light beams has a different respective angle of incidence on the optical element, and wherein a respective direction of the far-field illumination produced by the optical element differs for each of the light beams.

7. The apparatus of claim 1, wherein the optical element is a DOE.

8. The apparatus of claim 1, wherein the optical element is a MOE.

9. An apparatus comprising:
an array of optical elements, each of which is a diffractive optical element (DOE) or a meta-optical element (MOE); and
a plurality of light emitters, each of which is operable to produce respective intermediate light incident on a respective one of the optical elements,
wherein each particular one of the optical elements has a respective phase function configured to generate a respective far-field illumination based on the respective intermediate light incident on the particular one of the optical elements, and wherein the far-field illumination produced by the particular one of the optical elements is in a direction different from the far-field illuminations produced by other ones of the optical elements.

10. The apparatus of claim 9 wherein each of the light emitters is operable, respectively, to produce coherent light as the intermediate light.

11. The apparatus of claim 9, further including at least one collimator configured so that the intermediate light incident on the optical elements is substantially collimated.

12. The apparatus of claim 9, wherein the array of optical elements is a two-dimensional array.

13. The apparatus of claim 9, further including a controller operable to turn on different groupings of the light emitters at different times.

14. The apparatus of claim 9, wherein each of the optical elements is a DOE.

15. The apparatus of claim 9, wherein each of the optical elements is a MOE.

16. An apparatus comprising:
an optical element, wherein the optical element is a diffractive optical element (DOE) or a meta-optical element (MOE); and
a beam steering system operable to produce intermediate light incident on the optical element at any of different incident angles,
wherein the optical element is configured to generate a far-field illumination based on the intermediate light, and wherein a pattern of the far-field illumination depends on an angle at which the intermediate light is incident on the optical element.

17. The apparatus of claim 16 wherein the optical element is operable to generate a first pattern in the far-field illumination when the intermediate light is incident on the optical element at a first angle and to generate a second pattern in the far-field illumination when the intermediate light is incident on the optical element at a second angle, wherein the second angle differs from the first angle, and the second pattern differs from the first pattern.

18. The apparatus of claim 17 wherein the optical element is further operable to generate a third pattern in the far-field illumination when the intermediate light is incident on the optical element at a third angle, wherein the third angle differs from the first and second angles, and the third pattern differs from the first and second patterns.

19. The apparatus of claim 16, wherein the optical element is configured to be operable to produce at least two different respective patterns for the far-field illumination depending on an angle at which the intermediate light is incident on the optical element, wherein the patterns are from a group consisting of: a dot pattern, a line pattern, structured light, diffuse light, and light having a particular polarization.

20. The apparatus of claim 16, further including a controller operable to control the beam steering system to produce a sequence of two or more light beams, wherein each of the light beams has a different respective angle of incidence on the optical element, and wherein a respective pattern for the far-field illumination produced by the optical element differs for each of the light beams.

21. The apparatus of claim 16, wherein the optical element is a DOE.

22. The apparatus of claim 16, wherein the optical element is a MOE.
